(19) United States
(12) Patent Application Publication
(10) Pub. No.: US 2026/0189169 A1
(43) Pub. Date: Jul. 2, 2026

(54) ELECTRIC MOTOR CONTROL DEVICE AND STORAGE MEDIUM STORING ELECTRIC MOTOR CONTROL PROGRAM

(71) Applicant: DENSO CORPORATION, Kariya-city (JP)

(72) Inventors: Yuu YAMAHIRA, Kariya-city (JP); Masashi MASUMOTO, Kariya-city (JP)

(73) Assignee: DENSO CORPORATION, Kariya-city (JP)

(21) Appl. No.: 19/371,378

(22) Filed: Oct. 28, 2025

Related U.S. Application Data
(63) Continuation of application No. PCT/JP2024/017569, filed on May 13, 2024.

(30) Foreign Application Priority Data
May 25, 2023 (JP) 2023-086384

(51) Int. Cl. H02P 29/032; B60L 3/00; B60L 15/20; H02P 27/08

(52) U.S. Cl. CPC H02P 29/032; B60L 3/0061; B60L 15/20; H02P 27/08; B60L 2210/40; B60L 2240/421; B60L 2240/423

(57) ABSTRACT

When it is determined that an electric motor is locked, a control device limits a current flowing through the electric motor. A limit on the current flowing through the electric motor is ended when a release condition for determining whether a locked state of the electric motor is released continues to be satisfied for a specified period of time. Therefore, when the locked state of the electric motor is not completely released and the release conditions are temporarily satisfied but are soon no longer satisfied, the limitation on the current flowing through the electric motor is not terminated.

### CROSS REFERENCE TO RELATED APPLICATIONS

The present application is a continuation application of International Patent Application No. PCT/JP2024/017569 filed on May 13, 2024, which designated the U.S. and claims the benefit of priority from Japanese Patent Application No. 2023-086384 filed in Japan filed on May 25, 2023, the entire disclosure of the above application is incorporated herein by reference.

### TECHNICAL FIELD

The present disclosure relates to an electric motor control device and an electric motor control program that control an electric motor to which current is passed via an inverter.

### BACKGROUND ART

When an electric motor locks and an electric motor's rotational speed is in a low rotational speed range, a first torque and a second torque greater than the first torque are set, and a locked state control is executed in which the electric motor outputs a torque that is changed between the set first torque and second torque.

### SUMMARY

The present disclosure aims to provide an electric motor control device and a storage medium storing an electric motor control program that are capable of suppressing a large current from continuously flowing through elements that constitute an inverter before a locked state of the electric motor is completely released.

In order to achieve the above object, the present disclosure provides an electric motor control device for controlling an electric motor to which a current is passed via an inverter.

The electric motor control device includes;
a processor with a memory storing computer program code executable by the processor, the processor configured to cause the electric motor control device to:
determine a locked state of the electric motor,
limit a current supplied to the electric motor when the locked state determination unit determines that the electric motor is in a locked state,
determine whether a release condition for determining whether the locked state of the electric motor is released is satisfied, and
terminate limiting the current to the electric motor when a period during which the release condition is satisfied continues for a specified period, by regarding the electric motor as having exited the locked state.

Further, a storage medium storing an electric motor control program according to the present disclosure is an electric motor control program for controlling an electric motor to which a current is applied via an inverter.

The program includes instructions configured to, when executed by at least one processor, to cause the at least one processor to function as;
determining a locked state of the electric motor,
limiting a current supplied to the electric motor when it is determined that the electric motor is locked,
determining whether a release condition for determining whether the locked state of the electric motor is released is satisfied,
terminating a limit of the current to the electric motor when a period during which the release condition is satisfied continues for a specified period, by regarding the electric motor as having exited the locked state.

### BRIEF DESCRIPTION OF THE DRAWINGS

FIG. 1 is a diagram showing a schematic configuration of an entire system including a control device that controls an electric motor according to a first embodiment;

FIG. 2 is a flowchart showing a process executed by the control device each time a vehicle starts moving from a stopped state;

FIG. 3 is a flowchart showing details of a lock determination process in the flowchart of FIG. 2;

FIG. 4 is a flowchart showing details of a timer start process in the flowchart of FIG. 2;

FIG. 5 is a flowchart showing details of the release process of the flowchart of FIG. 2;

FIG. 6 is a time chart showing an example of operational waveforms in a case where the electric motor falls into a locked state when the vehicle starts moving, but the locked state is resolved while a current limit value is being applied to the electric motor;

FIG. 7 is a time chart showing an example of operational waveforms when the locked state of the electric motor is released after repeated determinations to release the locked state and cancellation determinations to cancel the determinations to release the locked state when the vehicle starts moving;

FIG. 8 is a flowchart showing details of a timer start process executed in a control device according to a second embodiment;

FIG. 9 is a flowchart showing details of a lock determination process performed in a control device according to a third embodiment;

FIG. 10 is a time chart showing an example of operational waveforms when the lock determination process shown in the flowchart of FIG. 9 is performed;

FIG. 11 is a flowchart showing details of a timer start process performed in a control device according to a fourth embodiment;

FIG. 12 is a flowchart showing details of a release process performed in a control device according to the fourth embodiment;

FIG. 13 is a time chart showing an example of operational waveforms when the timer start process shown in the flowchart of FIG. 11 and the release process shown in the flowchart of FIG. 12 are performed;

FIG. 14 is a time chart for explaining a process performed by a control device according to a fifth embodiment;

FIG. 15 is another time chart for explaining the process by the control device according to the fifth embodiment;

FIG. 16 is a time chart for explaining a process performed by a control device according to a sixth embodiment; and

FIG. 17 is another time chart for explaining the process by the control device according to the sixth embodiment.

### DETAILED DESCRIPTION

In an assumable example, when the electric motor locks and the electric motor's rotational speed is in a low rotational speed range, a first torque and a second torque greater than the first torque are set, and a locked state control is executed in which the electric motor outputs a torque that is changed between the set first torque and second torque.

Here, when a large current is passed through the electric motor in an attempt to generate a relatively large torque in the electric motor to release the electric motor from its locked state, current will continue to flow through the coils of the same phase, causing an increase in the temperature of the elements that constitutes an inverter that adjusts the current passed through the electric motor. For this reason, when the locked state continues for a certain period of time, it is desirable to limit the current flowing through the electric motor to a current of a magnitude capable of suppressing the temperature rise of the inverter elements, within a range in which the locked state can be expected to be resolved.

However, in the example, a torque of the electric motor is changed between a first torque and a second torque, and when the electric motor rotation speed exceeds a threshold value that defines a low rotation speed range, the electric motor's locked state is considered to be released. For this reason, when the locked state of the electric motor is not completely resolved and the electric motor speed once exceeds the threshold value, the locked state control will be executed again when the electric motor speed immediately drops to a value below the threshold value. When a torque that changes between the first torque and the second torque is generated as the locked state control, a relatively large current flows through the inverter element again. Therefore, when such locked state control is repeated, a large current will continuously flow through the inverter elements, which may result in an increase in temperature.

The present disclosure has been made in consideration of the above-mentioned points, and aims to provide an electric motor control device and an electric motor control program that are capable of suppressing a large current from continuously flowing through elements that constitute an inverter before a locked state of the electric motor is completely released.

In order to achieve the above object, the present disclosure provides an electric motor control device for controlling an electric motor to which a current is passed via an inverter.

The electric motor control device includes;
a processor with a memory storing computer program code executable by the processor, the processor configured to cause the electric motor control device to:
determine a locked state of the electric motor,
limit a current supplied to the electric motor when the locked state determination unit determines that the electric motor is in a locked state,
determine whether a release condition for determining whether the locked state of the electric motor is released is satisfied, and
terminate limiting the current to the electric motor when a period during which the release condition is satisfied continues for a specified period, by regarding the electric motor as having exited the locked state.

Further, a storage medium storing an electric motor control program according to the present disclosure is an electric motor control program for controlling an electric motor to which a current is applied via an inverter.

The program includes instructions configured to, when executed by at least one processor, to cause the at least one processor to function as;
determining a locked state of the electric motor,
limiting a current supplied to the electric motor when it is determined that the electric motor is locked,
determining whether a release condition for determining whether the locked state of the electric motor is released is satisfied,
terminating a limit of the current to the electric motor when a period during which the release condition is satisfied continues for a specified period, by regarding the electric motor as having exited the locked state.

According to the above-mentioned electric motor control device and electric motor control program, the limitation of the current flowing through the electric motor is terminated when a period during which the release condition for determining whether the locked state of the electric motor is released continues to be satisfied for a specified of time. Therefore, when the locked state of the electric motor is not completely released and the release conditions are temporarily satisfied but are soon no longer satisfied, the limitation on the current flowing through the electric motor is not terminated. This prevents the repetition of the lock control described in the example, and suppresses the continuous flow of large currents through the elements that constitutes the inverter before the locked state of the electric motor is completely released.

Hereinafter, embodiments for carrying out the present disclosure are described with reference to the drawings. In each embodiment, parts corresponding to the elements described in the preceding embodiments are denoted by the same reference numerals, and redundant explanation may be omitted. When only a part of the configuration is described in each embodiment, the previously described other embodiments can be applied to other parts of the configuration.

It is possible to combine parts that are explicitly stated to be specifically combinable in each embodiment. In addition, it may also be possible to partially combine the individual embodiments with each other, the embodiment with a modification, and the individual modifications with each other even though it is not explicitly stated that the combination is possible, as long as the combination has no particular problem.

### First Embodiment

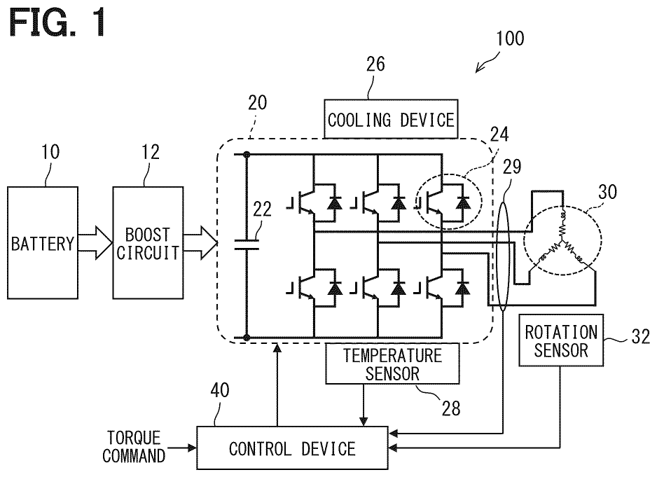

First, with reference to FIG. 1, a description will be given of the overall configuration of a system 100 including a control device 40 that controls an electric motor 30 to which a current is applied via an inverter. This system 100 is mounted on a vehicle such as an electric vehicle, a hybrid vehicle, or a fuel cell vehicle. The electric motor 30 generates driving force for driving the vehicle.

The system 100 includes a battery 10, a boost circuit 12, a power conversion circuit 20 including an inverter, a cooling device 26, an electric motor 30, and a control device 40. The battery 10 includes a plurality of cell stacks electrically connected in series or parallel. Each of the plurality of battery stacks includes a plurality of secondary batteries electrically connected in series. As the secondary batteries, a lithium-ion secondary battery, a nickel hydrogen secondary battery, an organic radical battery, or the like may be employed. The battery 10 may be a fuel cell.

The boost circuit 12 has a DC-DC converter and boosts the DC voltage of the battery 10 to a voltage level suitable for powering the electric motor 30. For example, the boost circuit 12 mainly boosts the DC power of the battery 10 in response to the amount of depression of the accelerator pedal by the vehicle driver so that the voltage level increases as the amount of depression increases. The boosting operation by the boost circuit 12 may be controlled by the control device 40 or may be controlled by a control device separate from the control device 40. The DC voltage boosted by the boost circuit 12 is charged into a smoothing capacitor 22 of the power conversion circuit 20.

The power conversion circuit 20 includes an inverter. The inverter converts the DC power supplied from the boost circuit 12 (smoothing capacitor 22) into AC power. This AC power is supplied to the electric motor 30, causing the electric motor 30 to rotate. Moreover, the inverter converts AC power generated (regenerated) by the electric motor 30 into DC power. The boost circuit 12 steps down this DC power to a voltage level suitable for charging the battery 10. This stepped-down DC power is supplied to the battery 10 and various electric loads of the vehicle.

The inverter is a three-phase inverter. A switching module 24 is provided on each of the upper and lower arms of each phase. The switching module 24 is composed of, for example, a semiconductor switch such as a MOSFET or an IGBT, and a diode connected in inverse parallel to the semiconductor switch. The midpoints between the upper and lower arms of each phase are connected to the U-phase coil, V-phase coil, and W-phase coil of the electric motor 30, respectively.

The power conversion circuit 20 is provided with a cooling device 26 and various sensors including a temperature sensor 28 and a current sensor 29. The cooling device 26 is configured, for example, to make a refrigerant flow through cooling pipes arranged to be capable of exchanging heat with each of the switching modules 24 corresponding to elements constituting an inverter. The cooling device 26 may be configured to change the flow rate of the refrigerant depending on the temperature of each switching module 24, for example. Specifically, the cooling device 26 may be configured to increase the flow rate of the refrigerant as the temperature of each switching module 24 increases, thereby adjusting the temperature of each switching module 24 within an appropriate temperature range.

The temperature sensor 28 is provided near each switching module 24 and detects the temperature of each switching module 24. A plurality of temperature sensors 28 may be provided, for example, for each switching module 24, or for each of a plurality of switching modules 24 arranged in the vicinity.

The current sensor 29 detects the current flowing through each connection line connecting the midpoint of each phase of the inverter to the U-phase coil, the V-phase coil, and the W-phase coil of the electric motor 30, respectively. When the rotation of the electric motor 30 is detected from the current detected by a current sensor, the rotation sensor 32 described below may be omitted.

As sensors other than the temperature sensor 28 and the current sensor 29, the power conversion circuit 20 may be provided with a voltage sensor, a refrigerant temperature sensor, a refrigerant flow rate sensor, etc. The voltage sensor detects the input voltage to the inverter, that is, the voltage across the smoothing capacitor 22. The refrigerant temperature sensor detects the temperature of the refrigerant in the cooling device 26. The refrigerant flow rate sensor detects the flow rate of the refrigerant in the cooling device 26. Both the refrigerant temperature and the refrigerant flow rate are correlated to the temperature of the switching module 24, which corresponds to an element that constitutes the inverter. In other words, both the refrigerant temperature and the refrigerant flow rate are parameters related to the temperature of the switching module 24 that constitutes the inverter.

The electric motor 30 has, for example, an output shaft, a rotor provided on the output shaft, and U-phase, V-phase, and W-phase stator coils arranged to face the outer periphery of the rotor. The output shaft of the electric motor 30 is connected to an axle of the driving wheels of the vehicle via, for example, a gearbox. Therefore, the rotational torque generated by the electric motor 30 is transmitted to the drive wheels of the vehicle via the gearbox and the axle. The electric motor 30 is powered by AC power supplied from the power conversion circuit 20. As a result, the driving force generated by the electric motor 30 is applied to the driving wheels.

The rotation sensor 32 may be a resolver, an MR sensor, an encoder, or the like, and outputs a detection signal according to the rotational position of the electric motor 30. The detection signal of the rotation sensor 32 is output to the control device 40.

The control device 40 has at least a storage unit and a calculation unit. The storage unit is a non-transient tangible storage medium that non-transiently stores data and programs that can be read by the processor. The storage unit has a volatile memory and a non-volatile memory. The volatile memory of the storage unit temporarily stores, for example, various pieces of information input to the control device 40 and the processing results of the calculation unit. The non-volatile memory of the storage unit stores, for example, various programs and various reference values for the calculation unit to perform calculation processing.

The calculation unit includes at least one processor. The calculation unit stores the various pieces of information input to the control device 40 in the storage unit. Furthermore, the calculation unit executes various calculation processes according to each instruction of the stored program based on the information stored in the storage unit, and outputs, for example, a control signal for controlling each switching module 24 of the inverter.

Specifically, the control device 40 receives a torque command indicating the torque to be generated by the electric motor 30 from a higher-level control device. The torque command may also be calculated by the control device 40 based on the amount of depression of the accelerator pedal, the vehicle speed, etc. The control device 40 converts the received torque command into a current command, outputs a control signal so that a current corresponding to the converted current command is supplied to the electric motor 30, and performs PWM control on each switching module of the inverter.

Furthermore, when starting a stopped vehicle by the torque generated by the electric motor 30, the control device 40 determines whether or not the electric motor 30 has entered a locked state. The locked state refers to a state in which the rotation speed of the electric motor 30 remains at a low rotation speed equal to or lower than the lock determination rotation speed even though the electric motor 30 generates a torque equal to or higher than a predetermined value. This state can occur, for example, when the vehicle is attempting to start on an uphill road or is experiencing resistance due to unevenness in the road surface when starting, causing a large resistance force when the electric motor 30 begins to rotate. When the control device 40 determines that the electric motor 30 has entered a locked state, it limits the current flowing through the electric motor 30 to a current of a magnitude capable of suppressing the temperature rise of the switching module 24 that constitutes the inverter, within a range in which the locked state can be expected to be resolved.

However, when the current limitation is terminated based on the fact that the rotation speed of the electric motor 30 exceeds the lock release determination rotation speed, the following problems may occur. For example, when the vehicle comes close to going over a bump in the road that has been causing resistance to starting, but is unable to go over it completely and returns to its original position, even if the rotation speed of the electric motor 30 once exceeds the lock release determination rotation speed, it is possible that the rotation speed will immediately drop to a speed below the lock release determination rotation speed. When such a phenomenon occurs repeatedly, then if the current limit is terminated and a large current corresponding to the torque command is passed through the inverter to the electric motor 30, a large current will flow through the inverter each time the lock release determination speed is exceeded. As a result, a large current may continuously flow through the switching module 24 corresponding to the elements that constitute the inverter, which may cause a rise in temperature.

Therefore, the control device 40 in the present embodiment is configured to terminate the limitation of the current flowing to the electric motor 30 not only when the lock release condition for determining whether the locked state of the electric motor 30 is released is satisfied, but also when the period during which the lock release condition is satisfied continues for a predetermined period of time. Therefore, when the locked state of the electric motor 30 is not completely released and the lock release condition is temporarily satisfied but is soon no longer satisfied, the limitation on the current flowing to the electric motor 30 is not terminated. Therefore, it is possible to prevent a large current from flowing through the switching module 24 that constitutes the inverter before the locked state of the electric motor 30 is completely released.

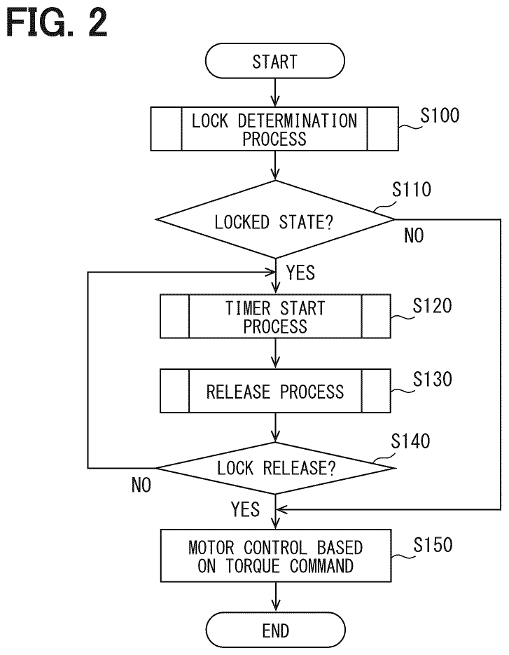

The process executed by the control device 40 in accordance with the stored program will now be described with reference to the flow chart of FIG. 2. The process shown in the flowchart of FIG. 2 is executed every time the vehicle starts moving from a stopped state.

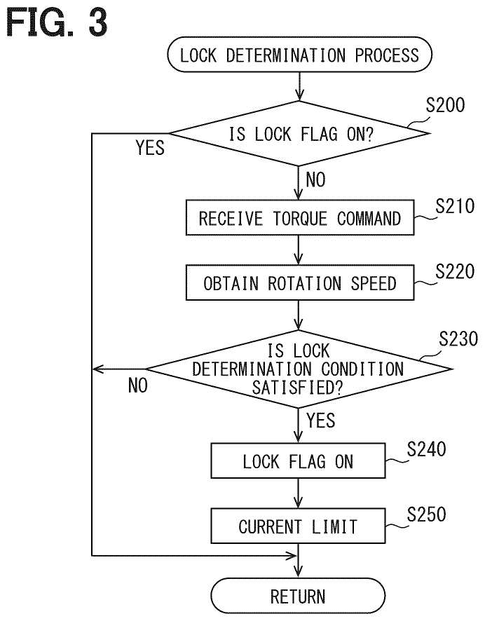

In step S100, the control device 40 executes a lock determination process. The details of the lock determination process are shown in the flowchart of FIG. 3. The lock determination process will be described below with reference to the flowchart of FIG. 3.

In step S200, the control device 40 determines whether or not the lock flag is on, that is, whether or not the locked state of the electric motor 30 has already been determined. The lock flag is turned on in step S240 when a lock determination condition is satisfied in step S230, which will be described later. When it is determined that the lock flag is on, there is no need to perform further lock determination, and so the control device 40 ends the process shown in the flowchart of FIG. 3. On the other hand, when it is determined that the lock flag is not on, the control device 40 proceeds to the process of step S210.

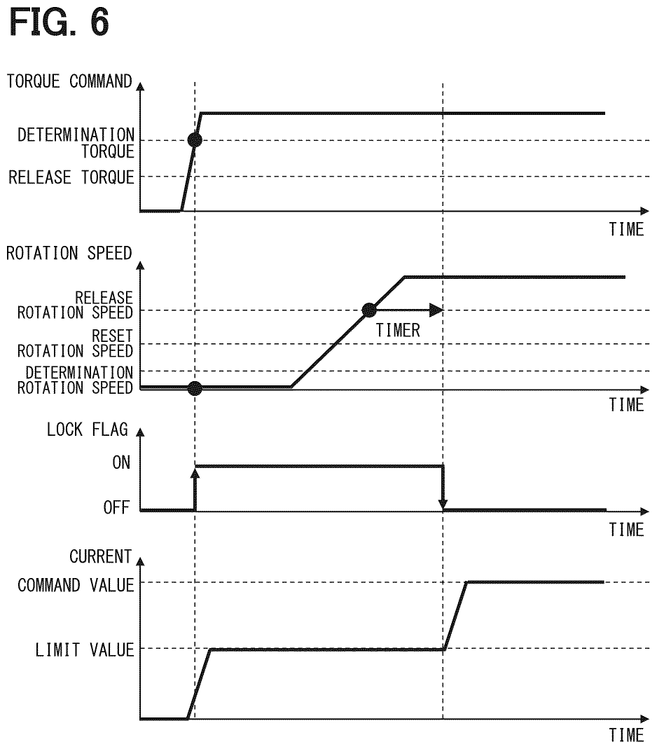

In step S210, the control device 40 receives a torque command from a higher-level control device. In step S220, the control device 40 calculates and obtains the rotation speed of the electric motor 30 based on the detection signal of the rotation sensor 32 or the detection signal of the current sensor. In step S230, the control device 40 determines whether or not the electric motor 30 is in a locked state, depending on whether or not a lock determination condition is satisfied. The lock determination condition can be, for example, as shown in the time chart of FIG. 6, that the torque command is equal to or greater than the lock determination torque and the rotation speed of the electric motor 30 is equal to or less than the lock determination rotation speed. This is because, even if a torque command of a certain magnitude is issued, when the actual rotation speed of the electric motor 30 is low and equal to or lower than the lock determination rotation speed, the electric motor 30 can be regarded as being in the locked state. However, the lock determination condition is not limited to the above condition. For example, instead of the torque command, a current command converted from the torque command may be used. FIG. 6 is a time chart showing an example of an operational waveform in a case where the electric motor 30 falls into the locked state when the vehicle starts moving, but the locked state is resolved while current is being limited and a current limit value is being applied to the electric motor 30.

When it is determined in step S230 that the lock determination condition is satisfied, the control device 40 proceeds to the process of step S240. On the other hand, when it is determined that the lock determination condition is not satisfied, the electric motor 30 is not in a locked state, and therefore the control device 40 ends the process shown in the flowchart of FIG. 3.

In step S240, the control device 40 turns on the lock flag which indicates that the electric motor 30 is in the locked state, as shown in the time chart of FIG. 6. In step S250, the control device 40 limits the current flowing through the electric motor 30 to a current limit value that is large enough to suppress the temperature rise of the switching module 24 that constitutes the inverter, within a range in which the locked state can be expected to be resolved, as shown in the time chart of FIG. 6. The lock determination process is ended. The lock determination process may be repeatedly executed until a predetermined time has elapsed since the vehicle starts moving.

Referring again to FIG. 2, in step S110, the control device 40 determines whether or not it has been determined in the lock determination process that the electric motor 30 is in the locked state. When it is determined that the electric motor 30 is in the locked state, the control device 40 proceeds to the process of step S120. On the other hand, when it is determined that the electric motor 30 is not in the locked state, the control device 40 proceeds to step S150.

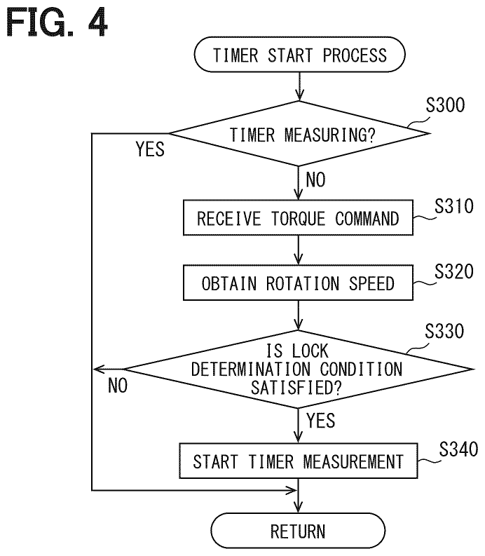

In step S120, the control device 40 executes a timer start process. The details of the timer start process are shown in the flow chart of FIG. 4. The timer start process will be described below with reference to the flowchart of FIG. 4.

In step S300, the control device 40 determines whether or not the timer is currently measuring, that is, whether or not the timer has already started measuring in response to the lock release condition being satisfied. When the control device 40 determines in step S330 that the lock release condition is satisfied, the timer starts measuring in step S340. When it is determined that the timer is measuring, the control device 40 does not need to determine whether or not to start measuring the timer, and therefore ends the process shown in the flowchart of FIG. 4. On the other hand, when it is determined that the timer is not currently measuring, the control device 40 proceeds to the process of step S310.

In step S310, the control device 40 receives a torque command from a higher-level control device. In step S320, the control device 40 obtains the rotation speed of the electric motor 30 based on the detection signal of the rotation sensor 32 or the detection signal of the current sensor. In step S330, the control device 40 determines whether the locked state of the electric motor 30 has been released based on whether the lock release condition is satisfied. The lock release condition can be, for example, that the rotation speed of the electric motor 30 is equal to or higher than the lock release rotation speed, as shown in the time chart of FIG. 6. This is because, when the rotation speed of the electric motor 30 becomes equal to or higher than the lock release rotation speed, it can be determined that the locked state of the electric motor 30 is released at that point in time.

The lock release condition is not limited to the above condition. For example, in the case where the carrier frequency for PWM control changes proportionally in accordance with the rotation speed of the electric motor 30, the lock release of the electric motor 30 may be determined when the carrier frequency becomes equal to or higher than the lock release frequency. In other words, the carrier frequency is a parameter that correlates with and is related to the rotation speed of the electric motor 30, and the lock release condition may be set for this carrier frequency.

Furthermore, the lock release condition may be that the torque command is equal to or lower than the lock release torque, as shown in the time chart of FIG. 6. When the electric motor 30 enters the locked state, the driver of the vehicle may not continue to depress the accelerator pedal, but may release the accelerator pedal once and then depress it again. When the driver releases the accelerator pedal, the torque command also decreases. Therefore, when the torque command falls below the lock release torque, it can be considered that the locked state of the electric motor 30 is released at that point in time. When the lock release condition regarding the torque command is not determined, the process of step S310 may be omitted. In addition, when the boost voltage by the boost circuit 12 changes proportionally in response to the torque command, the determination as to whether the electric motor 30 is unlocked may also be performed when the boost voltage of the boost circuit 12, i.e., the voltage across the smoothing capacitor 22, becomes lower than the lock release voltage. In other words, the voltage across the smoothing capacitor 22 is a parameter that correlates with and is related to the torque command, and the lock release condition may be set for this voltage across the smoothing capacitor 22.

In addition, the lock release condition may be set for the temperature of the elements constituting the inverter, that is, the temperature of the switching module 24, or the refrigerant temperature or the refrigerant flow rate of the cooling device 26. For example, when the temperature of the switching module 24 drops below a predetermined threshold temperature, the temperature rise of the switching module 24 is likely to be within an appropriate temperature range even if a large current continues to flow through the switching module 24. For this reason, when the temperature of the switching module 24 is equal to or lower than a predetermined threshold temperature, it is not necessary to continue to determine whether the electric motor 30 is in the locked state in order to limit the current flowing to the electric motor 30. The refrigerant temperature and refrigerant flow rate of the cooling device 26 are parameters that correlate with and are related to the temperature of the switching module 24. Therefore, the lock release condition may be set with respect to the refrigerant temperature or refrigerant flow rate of the cooling device 26 instead of the temperature of the switching module 24.

When it is determined in step S330 that the lock release condition is satisfied, the control device 40 proceeds to the process of step S340. On the other hand, when it is determined that the lock release condition is not satisfied, the control device 40 ends the process shown in the flowchart of FIG. 4.

In step S340, the control device 40 starts measurement by a timer as shown in the timing chart of FIG. 6. As described later, in the present embodiment, when the time measured by the timer reaches a predetermined period set in accordance with the lock release condition without the lock release cancellation conditions that cancel the lock release determination being satisfied, the control device 40 determines for the first time that the locked state of the electric motor 30 has been released. This completes the timer start process.

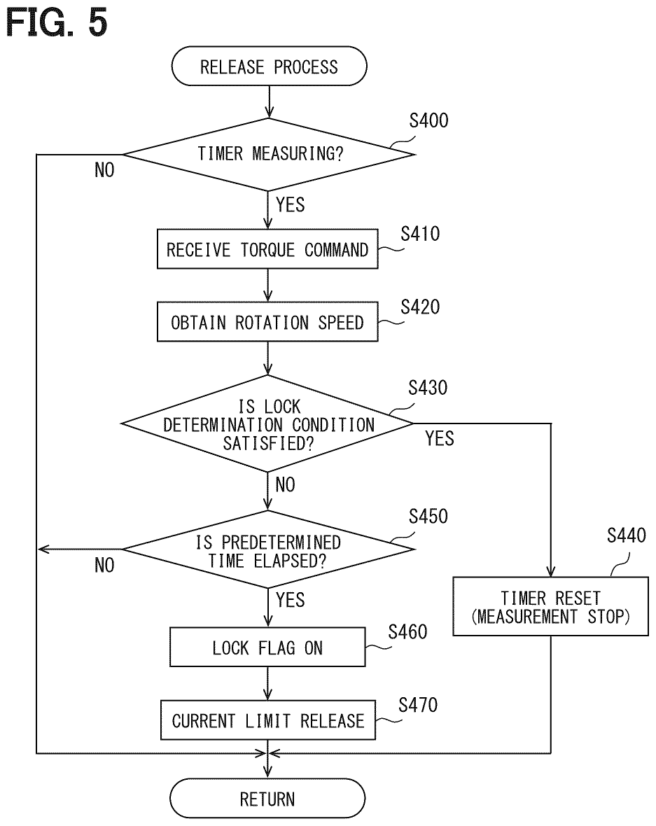

Referring again to FIG. 2, following the timer start process in step S120, the control device 40 executes the release process in step S130. The release process is shown in detail in the flow chart of FIG. 5. The release process will be described below with reference to the flowchart of FIG. 5.

In step S400, the control device 40 determines whether the timer is measuring. When it is determined that the timer is currently measuring, the control device 40 proceeds to the process of step S410. On the other hand, when it is determined that the timer is not currently measuring, the control device 40 does not need to determine whether the time measured by the timer has reached the predetermined period, and therefore ends the process shown in the flowchart of FIG. 5.

In step S410, the control device 40 receives a torque command from a higher-level control device. In step S420, the control device 40 obtains the rotation speed of the electric motor 30 based on the detection signal of the rotation sensor 32 or the detection signal of the current sensor. In step S430, the control device 40 determines whether or not a release cancellation condition is satisfied. The release cancellation condition is a criterion for canceling the lock release when the lock release condition, which is the criterion for determining that the locked state of the electric motor 30 has been released, is satisfied once, but the locked state of the electric motor 30 has not been completely released thereafter.

For example, when the lock release condition is set based on the rotation speed of the electric motor 30, the release cancellation condition can be that the rotation speed of the electric motor 30, which has become equal to or greater than the release rotation speed, has dropped to or below the reset rotation speed which is set to be equal to or less than the release rotation speed, as shown in the time chart of FIG. 6. Also, for example, when the lock release condition is set based on a torque command, it can be determined that the torque command that has fallen below the release torque has risen above a reset torque (not shown) that is set above the release torque. Furthermore, for example, when the lock release condition is set based on the temperature of the switching module 24, it can be determined that the temperature of the switching module 24, which had dropped below a predetermined threshold temperature, has risen to a cancellation temperature that is set higher than the predetermined threshold temperature.

When it is determined that the release cancellation condition is satisfied, the control device 40 proceeds to the process of step S440. In step S440, the control device 40 resets the timer that is currently measuring, and stops measuring, by the timer, the elapsed time since the lock release condition was satisfied. Thereafter, the control device 40 ends the process shown in the flowchart of FIG. 5.

On the other hand, when it is determined that the release cancellation condition is not satisfied, the control device 40 proceeds to the process of step S450. In step S450, the control device 40 determines whether or not the time measured by the timer has reached a predetermined time equivalent to a predetermined period set in accordance with the lock release condition. For example, as shown in the time chart of FIG. 6, when the time measured by the timer reaches a predetermined time, the control device 40 determines that the locked state of the electric motor 30 has been released, and proceeds to the process of step S460. Thus, in the present embodiment, when the time measured by the timer reaches a predetermined period set corresponding to the lock release condition without the release cancellation condition being satisfied, the control device 40 determines for the first time that the locked state of the electric motor 30 has been released.

In step S460, the control device 40 turns off the lock flag as shown in the time chart of FIG. 6. Furthermore, in step S470, the control device 40 releases the current limitation as shown in the time chart of FIG. 6. As a result, the current flowing through the electric motor 30 increases to a current command value corresponding to the torque command. Thereafter, in step S150 of the flow chart of FIG. 1, the control device 40 PWM controls the electric motor 50 so that a current corresponding to the torque command flows.

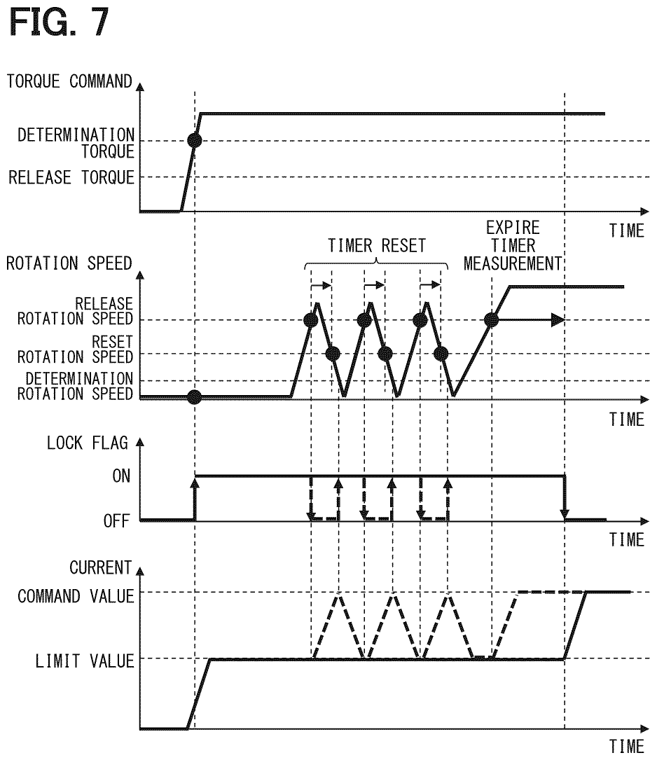

Here, when it is determined that the locked state of the electric motor 30 has been released when the lock release condition is satisfied, the lock flag will be turned off when the rotation speed of the electric motor 30 exceeds the release rotation speed, for example, as shown by the dotted line in the time chart of FIG. 7. Then, as indicated by the dotted line in the time chart of FIG. 7, the current value of the current supplied to the electric motor 30 increases toward the current command value corresponding to the torque command. However, thereafter, the rotation speed of the electric motor 30 falls below the lock determination rotation speed, and it is again determined that the electric motor 30 is in the locked state. In response to this determination of the locked state, the current supplied to the electric motor 30 is reduced toward the current limit value, as shown by the dotted line in the time chart of FIG. 7.

In this way, when the locked state of the electric motor 30 is not completely released and the rotation speed of the electric motor 30 temporarily exceeds the lock release rotation speed but then quickly drops below the lock determination rotation speed, a large current will repeatedly flow through the electric motor 30, as shown by the dotted line in the time chart of FIG. 7. As a result, there is concern that the switching module 24 constituting the inverter may experience an excessive rise in temperature.

In contrast, according to the present embodiment, the control device 40 starts measuring the elapsed time using a timer when the lock release condition (greater than or equal to the lock release rotation speed) for determining whether the locked state of the electric motor 30 is released is satisfied. When the locked state of the electric motor 30 is not completely released and the release cancellation condition for canceling the lock release condition (less than or equal to the reset rotation speed) is satisfied, the timer being measured is reset and measurement of the elapsed time by the timer is stopped, as shown in the time chart of FIG. 7. In the present embodiment, the control device 40 determines that the locked state of the electric motor 30 has been released only when the elapsed time measured by the timer reaches a predetermined period, i.e., when the measurement by the timer expires.

Therefore, in the present embodiment, as shown in the time chart of FIG. 7, the lock flag is not turned off when the lock release condition is satisfied, but remains on. Therefore, even in a situation where the lock release condition is temporarily satisfied but the lock determination is soon repeated, the current flowing to the electric motor 30 can be continuously limited to the current limit value. As a result, it is possible to prevent the temperature of the switching module 24 constituting the inverter from increasing excessively until the locked state of the electric motor 30 is completely released.

### Second Embodiment

Next, a control device 40 for the electric motor 30 according to a second embodiment of the present disclosure will be described. The control device 40 according to the present embodiment is configured similarly to the control device 40 according to the first embodiment, and therefore a description of the configuration will be omitted.

In the above-described first embodiment, it has been described that the lock release condition can be set for the temperature of the switching module 24 constituting the inverter, or the refrigerant temperature or refrigerant flow rate of the cooling device 26. In this case, when the lock release condition is satisfied, the timer starts counting. Then, when the time measured by the timer reaches a predetermined period determined for the temperature of the switching module 24, or the refrigerant temperature of the cooling device 26, or the refrigerant flow rate of the cooling device 26, the control device 40 determines that the locked state of the electric motor 30 has been resolved.

However, the temperature of the switching module 24, or the temperature of the cooling device 26, or the refrigerant flow rate of the cooling device 26 may be used to change the specified period corresponding to the lock release condition set for the rotation speed and/or torque command of the electric motor 30, or a parameter related to at least one of them, rather than setting each lock release condition.

For example, based on the temperature of the switching module 24 or a parameter related thereto, such as the refrigerant temperature or refrigerant flow rate of the cooling device 26, the control device 40 can set the predetermined period so as to shorten the predetermined period corresponding to the lock release condition set for the rotation speed and/or torque command of the electric motor 30, or a parameter related to at least one of them, when the temperature of the switching module 24 is low compared to when it is high. When the temperature of the switching module 24 is relatively low, there is little concern that the temperature of the switching module 24 will rise beyond the appropriate temperature range, even if a large current is continuously passed through the same switching module 24 to release the locked state of the electric motor 30. Therefore, when the temperature of the switching module 24 is relatively low, this is because there is no problem in shortening the predetermined period of time and quickly determining that the locked state of the electric motor 30 has been released.

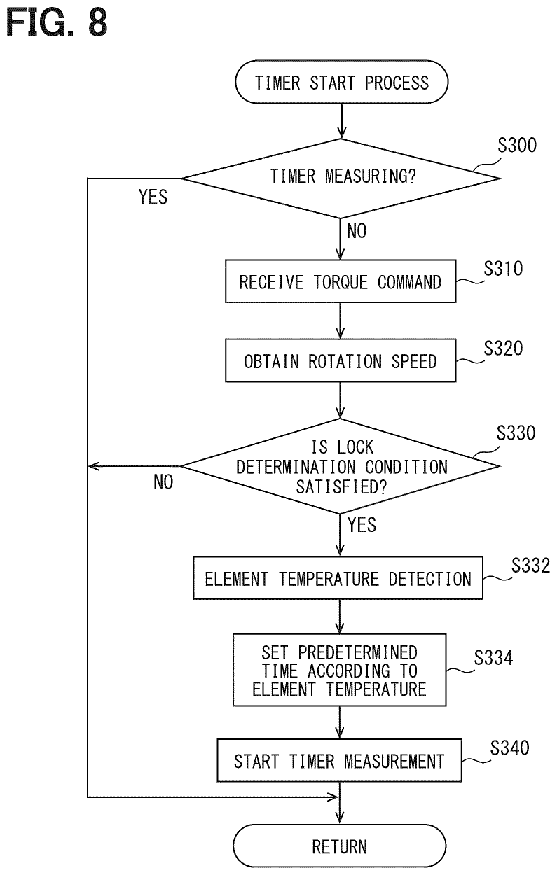

The flowchart in FIG. 8 shows a timer start process executed in the control device 40 according to the second embodiment. The timer start process shown in the flowchart of FIG. 8 is the same as the timer start process shown in the flowchart of FIG. 4 in the first embodiment, except that steps S332 and S334 are added.

In step S332, the control device 40 detects the temperature of the switching module 24, which corresponds to an element that constitutes the inverter, or a parameter related to the temperature of the switching module 24. In step S334, the control device 40 sets a predetermined period of time corresponding to the lock release condition set for the rotation speed and/or torque command of the electric motor 30, or a parameter related to at least one of them, depending on the detected temperature of the switching module 24 or a related parameter. At this time, as described above, the predetermined period is set to be shorter when the temperature of the switching module 24 is low than when it is high.

### Third Embodiment

Next, a control device 40 for the electric motor 30 according to a third embodiment of the present disclosure will be described. The control device 40 according to the present embodiment is configured similarly to the control device 40 according to the first embodiment, and therefore a description of the configuration will be omitted.

The control device 40 according to the first embodiment described above, as shown in the time chart of FIG. 6, immediately limits the current flowing through the electric motor 30 to a current limit value when it determines that the electric motor 30 is in the locked state. However, when the electric motor 30 falls into the locked state, the locked state of the electric motor 30 may be released by temporarily supplying a large current to the electric motor 30. In this case, the vehicle can start moving smoothly, improving drivability when starting.

Therefore, the control device 40 according to the present embodiment does not immediately limit the current flowing to the electric motor 30 even if it determines that the electric motor 30 is in a locked state, but instead flows a large value of current corresponding to the torque command to the electric motor 30 for a certain reservation period.

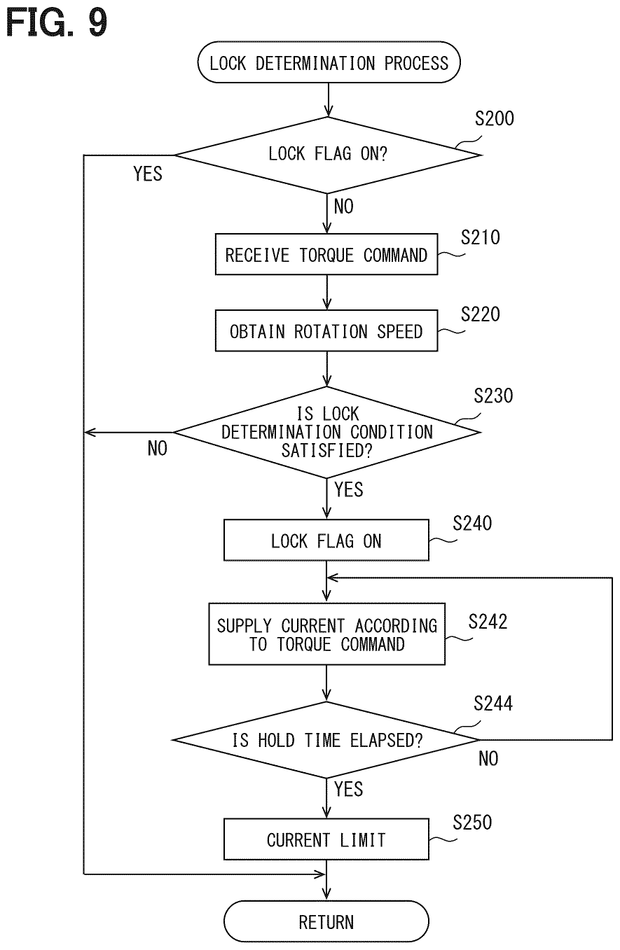

The flowchart in FIG. 9 shows a lock determination process executed in the control device 40 according to the third embodiment. The lock determination process shown in the flowchart of FIG. 9 is obtained by adding steps S242 and S244 to the lock determination process shown in the flowchart of FIG. 3 in the first embodiment.

In step S242, which is after it has been determined in step S230 that the electric motor 30 is in a locked state, the control device 40 supplies a current to the electric motor 30 in accordance with the torque command. Then, in step S242, the control device 40 determines whether or not the time that has elapsed since it was determined in step S230 that the electric motor 30 is in the locked state has reached a reservation time. When the elapsed time has reached the reservation time, the control device 40 proceeds to the process of step S250, and when the elapsed time has not reached the reservation time, the control device 40 continues the process of step S242.

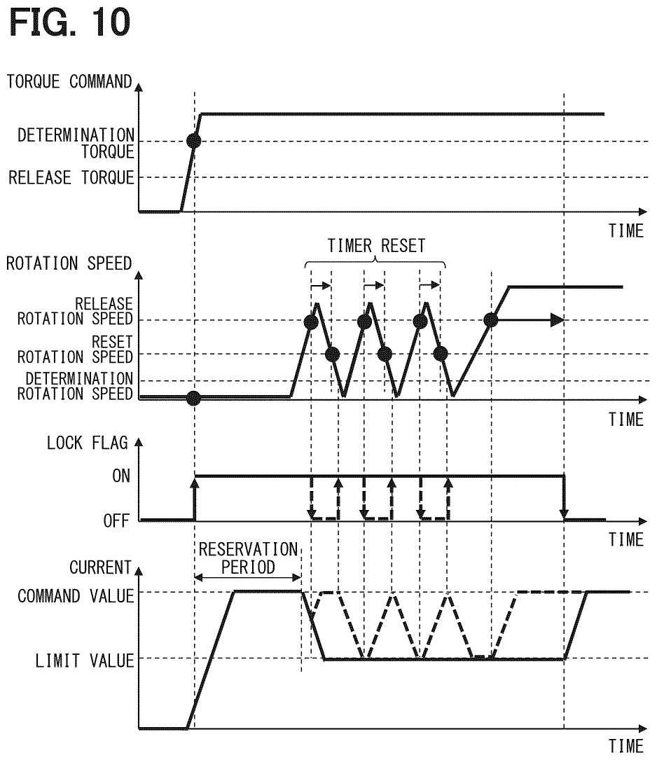

As a result, as shown in the time chart of FIG. 10, even after it is determined that the electric motor 30 is in the locked state and the lock flag is turned on, a large current corresponding to the torque command is supplied to the electric motor 30 until the reservation period has elapsed. Therefore, the locked state of the electric motor 30 can be quickly released. After the reservation period has elapsed, the current value supplied to the electric motor 30 is limited to the current limit value. Therefore, even if the locked state is not released by passing a large current during the reservation period, the temperature rise of the switching module 24 can be suppressed. In the present embodiment, when the lock flag is turned on and the reservation period starts, a timer start process is executed.

### Fourth Embodiment

Next, a control device 40 for the electric motor 30 according to a fourth embodiment of the present disclosure will be described. The control device 40 according to the present embodiment is configured similarly to the control device 40 according to the first embodiment, and therefore a description of the configuration will be omitted.

In the control device 40 according to the first embodiment, it is determined whether or not the locked state of the electric motor 30 has been released based on one lock release condition. In contrast, the control device 40 according to the present embodiment is different in that a plurality of lock release conditions are set, and whether or not the locked state of the electric motor 30 is released is determined based on the plurality of lock release conditions.

The plurality of lock release conditions may be set for multiple parameters, including the rotation speed of the electric motor 30, the torque command that commands the torque that the electric motor 30 should generate, and the temperature of the switching module 24 that constitutes the inverter, as well as parameters that are correlated and related to them. Additionally, or alternatively, the plurality of lock release conditions may be set for one of the parameters, such as the rotation speed of the electric motor 30, the torque command that commands the torque to be generated by the electric motor 30, and the temperature of the switching module 24 that constitutes the inverter, as well as parameters that are correlated and related thereto.

When the plurality of lock release conditions are set for multiple parameters, for example, a lock release rotation speed (e.g., 100 rpm) and a predetermined period (e.g., 50 ms) may be set for the rotation speed of the electric motor 30, a lock release torque (e.g., 10 Nm) and a predetermined period (e.g., 100 ms) may be set for the torque command, a lock release temperature (e.g., 100° C.) and a predetermined period (e.g., 10 ms) may be set for the temperature of the switching module 24, and a lock release temperature (e.g., 25° C.) and a predetermined period (e.g., 10 ms) may be set for the refrigerant temperature. Furthermore, the lock release conditions relating to other parameters may be added, and some of the lock release conditions described above may be deleted, so long as the plurality of lock release conditions remain.

In addition, when the plurality of lock release conditions are set for one parameter, for example, for the rotation speed of the electric motor 30, a first lock release rotation speed (e.g., 100 rpm) and a first specified period (e.g., 50 ms) may be set, a second lock release rotation speed (e.g., 300 rpm) and a second specified period (e.g., 30 ms) may be set, and a third lock release rotation speed (e.g., 500 rpm) and a third specified period (e.g., 10 ms) may be set. The parameter for which a plurality of lock release conditions are set is not limited to the rotation speed of the electric motor 30, but may be a torque command or other parameters. Furthermore, the number of lock release conditions set for one parameter may be two or more. For example, when the plurality of lock release conditions are set for a torque command, they include at least a first lock release condition in which the torque command is equal to or less than a first torque, and a second lock release condition in which the torque command is equal to or less than a second torque lower than the first torque, and the specified period individually determined for the second lock release condition is set to be shorter than the specified period individually determined for the first lock release condition.

In this way, when the plurality of lock release conditions are set for a plurality of parameters and/or for one parameter, the specified period is determined individually for each of the plurality of lock release conditions. Then, when the control device 40 determines that the period during which each of the plurality of lock release conditions is satisfied has reached a predetermined period individually determined for each of the plurality of lock release conditions, it considers that the locked state of the electric motor 30 has been released and terminates the current limiting of the electric motor 30.

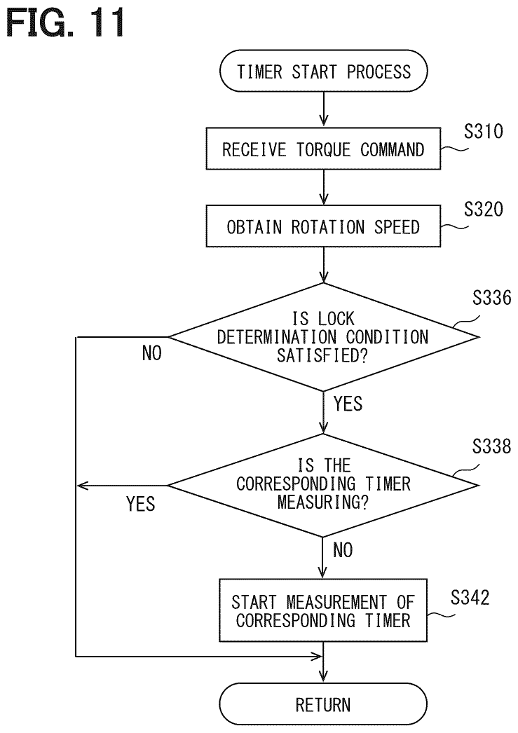

The flowchart in FIG. 11 shows a timer start process executed in the control device 40 according to the fourth embodiment. In the timer start process shown in the flowchart of FIG. 11, the processes of steps S300, S330, and S340 are deleted from the timer start process shown in the flowchart of FIG. 4 in the first embodiment, and processes of steps S336, S338, and S342 are added.

In step S336, the control device 40 determines whether or not one or more lock release conditions are satisfied among the plurality of lock release conditions are set for a plurality of parameters and/or one parameter. When none of the lock release conditions is satisfied, the control device 40 ends the process shown in the flowchart of FIG. 11. On the other hand, if it is determined that one or more lock release conditions are satisfied, the control device 40 proceeds to the process of step S338. In step S338, the control device 40 determines whether or not the timer corresponding to the lock release condition that has been determined to be satisfied is currently measuring. When the corresponding timer is currently measuring, the control device 40 ends the process shown in the flowchart of FIG. 11. On the other hand, when the corresponding timer is not currently measuring, the control device 40 proceeds to the process of step S342 and starts measuring the corresponding timer.

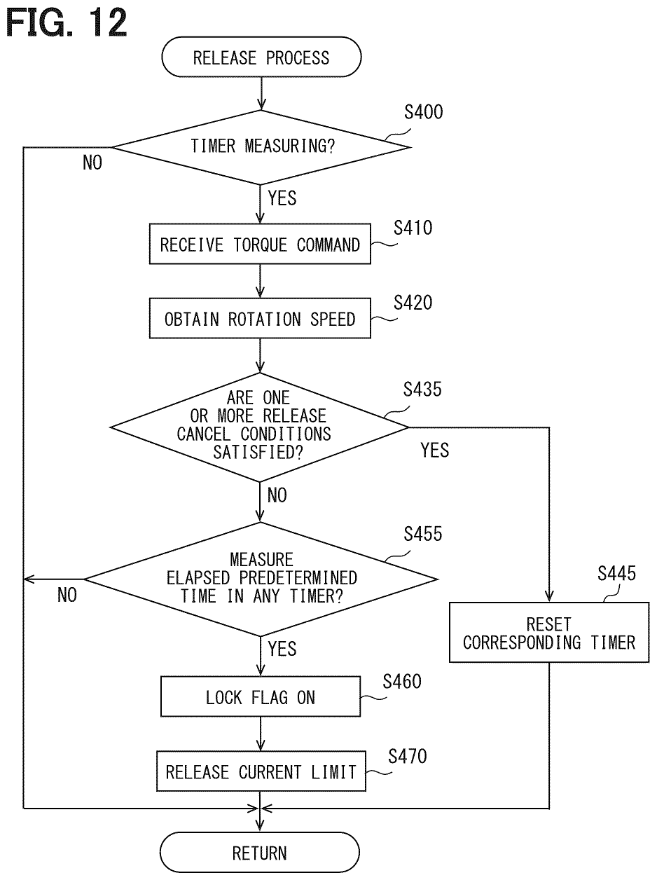

The flowchart in FIG. 12 shows the release process executed by the control device 40 according to the fourth embodiment. In the release process shown in the flowchart of FIG. 12, the processes of steps S430, S440, and S450 are deleted from the release process shown in the flowchart of FIG. 5 in the first embodiment, and processes of steps S435, S445, and S455 are added.

In step S435, the control device 40 determines whether or not one or more release cancellation conditions are satisfied. The release cancellation condition is determined individually for each of the multiple lock release conditions. For example, when the first to third lock release rotation speeds are set as described above for the rotation speed of the electric motor 30, the first to third lock release cancellation rotation speeds are determined individually for the first to third lock release rotation speeds so as to be equal to or lower than the corresponding first to third lock release rotation speeds.

When it is determined that one or more release cancellation conditions are satisfied, the control device 40 proceeds to the process of step S445. In step S445, the control device 40 first selects one or more lock release conditions that correspond to the one or more release cancellation conditions that have been satisfied. Then, the control device 40 resets one or more timers (hereinafter referred to as the relevant timers) that started measuring the time when the selected lock release condition was satisfied, and stops measuring the elapsed time since the selected lock release condition was satisfied by the relevant timers. Thereafter, the control device 40 ends the process shown in the flowchart of FIG. 12.

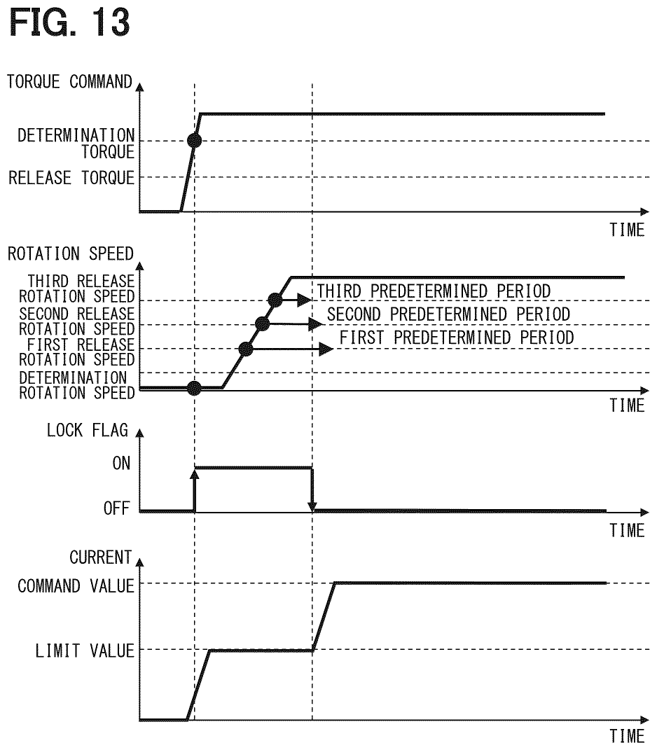

FIG. 13 is a time chart illustrating the period from the start to the end of measurement of each timer corresponding to each lock release condition when, for example, first to third lock release rotation speeds are set as the plurality of lock release conditions for the rotation speed of the electric motor 30 as a single parameter. As shown in the time chart of FIG. 13, for the first to third lock release rotation speeds, the higher the lock release rotation speed is, i.e., the higher the possibility that the locked state of the electric motor 30 has been released, the shorter the corresponding specified period is set.

When the locked state of the electric motor 30 is actually released, the rotation speed of the electric motor 30 increases beyond the first to third lock release rotation speeds. In this case, as shown in the time chart of FIG. 13, the order in which the timers corresponding to the lock release rotation speeds start measuring is the first lock release rotation speed, the second lock release rotation speed, and the third lock release rotation speed. However, the specified periods set corresponding to the respective lock release rotation speeds are set to be shorter as the lock release rotation speeds become higher. Therefore, the order in which the specified periods corresponding to the respective lock release rotation speeds are reached is reversed, that is, the third lock release rotation speed, the second lock release rotation speed, and the first lock release rotation speed.

In this way, by individually setting the plurality of lock release conditions and a specified period corresponding to each lock release condition for one parameter, it is possible to terminate the determination of the locked state of the electric motor 30 early when the locked state of the electric motor 30 is actually released. As a result, the drivability of the vehicle can be improved when the locked state of the electric motor 30 is released.

### Fifth Embodiment

Next, a control device 40 for the electric motor 30 according to a fifth embodiment of the present disclosure will be described. The control device 40 according to the present embodiment is configured similarly to the control device 40 according to the first embodiment, and therefore a description of the configuration will be omitted.

The control device 40 according to the first embodiment described above determines whether or not the specified period set in accordance with the lock release condition has elapsed based on the elapsed time measured by the timer. In contrast, the control device 40 of the present embodiment determines whether the lock release conditions are satisfied at regular intervals, and determines whether the specified period set corresponding to the lock release conditions has elapsed based on whether the lock release conditions are satisfied a specified number of times in succession. Even in this manner, it is possible to determine that the period during which the lock release condition is satisfied has continued for the specified period.

Furthermore, as in the fourth embodiment, when the plurality of lock release conditions are set and multiple specified periods are set individually corresponding to the plurality of lock release conditions, the specified number of times in succession that it is determined that the lock release conditions are satisfied (i.e., the number of determinations) can be varied according to the specified period, thereby making it possible to determine whether each of the specified periods set individually corresponding to the plurality of lock release conditions has elapsed.

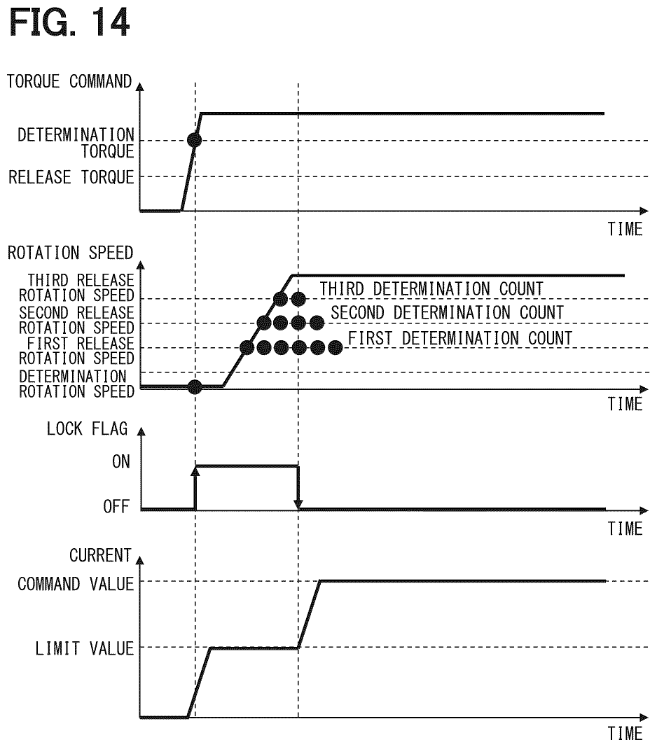

For example, when the plurality of lock release conditions, ie, first to third lock release rotation speeds, are set for the rotation speed of the electric motor 30 as one parameter, FIG. 14 is a time chart showing an example of determining whether each predetermined period corresponding to each lock release condition has elapsed by changing the predetermined number of times for determining that each lock release rotation speed is satisfied for each lock release rotation speed. In the example shown in the time chart of FIG. 14, the first determination number for the first lock release rotation speed is set to 6, the second determination number for the second lock release rotation speed is set to 4, and the third determination number for the third lock release rotation speed is set to 2.

As a result, similarly to the fourth embodiment, the rotation speed of the electric motor 30 satisfies each of the lock release rotation speeds in the order of the first lock release rotation speed, the second lock release rotation speed, and the third lock release rotation speed. However, the order in which the predetermined number of times for each lock release rotation count is satisfied is reversed, that is, the third lock release rotation count, the second lock release rotation count, and the first lock release rotation count.

In addition, instead of the number of determinations, the regular interval (i.e., determination period) for determining whether or not the lock release condition is satisfied can also be made different for each lock release condition to determine whether or not the specified period corresponding to each lock release condition has elapsed.

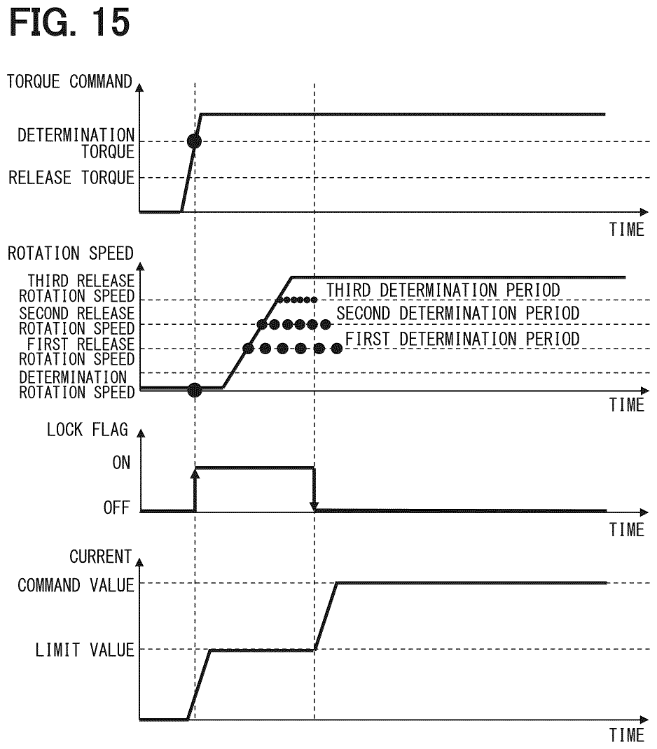

For example, when the plurality of lock release conditions, i.e., first to third lock release rotation speeds, are set for the rotation speed of the electric motor 30 as one parameter, FIG. 15 is a time chart showing an example of determining whether each predetermined period corresponding to each lock release condition has elapsed by changing the determination period for determining that each lock release rotation speed is satisfied for each lock release rotation speed. In the example shown in the time chart of FIG. 15, the number of determinations to determine whether each lock release rotation speed is satisfied is the same and set to 6. However, the determination period for determining whether or not the first lock release rotation speed is satisfied is set to the first determination period, which is the longest period. The determination period for determining whether the second lock release rotation speed is satisfied is set to a second determination period of intermediate length. The determination period for determining whether the third lock release rotation speed is satisfied is set to the shortest third determination period.

As a result, just as in the case where the determination number is different for each lock release rotation number, the order in which the same determination number is satisfied for each lock release rotation number is the third lock release rotation number, the second lock release rotation number, and the first lock release rotation number.

When a plurality of lock release conditions are set, both the number of determinations and the determination period may be different for each lock release condition.

### Sixth Embodiment

Next, a control device 40 for the electric motor 30 according to a sixth embodiment of the present disclosure will be described. The control device 40 according to the present embodiment is configured similarly to the control device 40 according to the first embodiment, and therefore a description of the configuration will be omitted.

In the control device 40 according to the sixth embodiment, at least one second lock release condition is defined for determining that the locked state of the electric motor 30 has been released with a higher probability than the lock release condition for a parameter for which the lock release condition is set. Then, the control device 40 determines at predetermined intervals whether the lock release condition and the second lock release condition are satisfied.

While the lock release condition is continuously satisfied, the control device 40 calculates the total score of the score when the lock release condition is satisfied and the score when the second lock release condition set higher than the score when the lock release condition is satisfied. When this total score exceeds a threshold value, the control device 40 assumes that the predetermined period has elapsed and determines that the locked state of the electric motor 30 has been resolved.

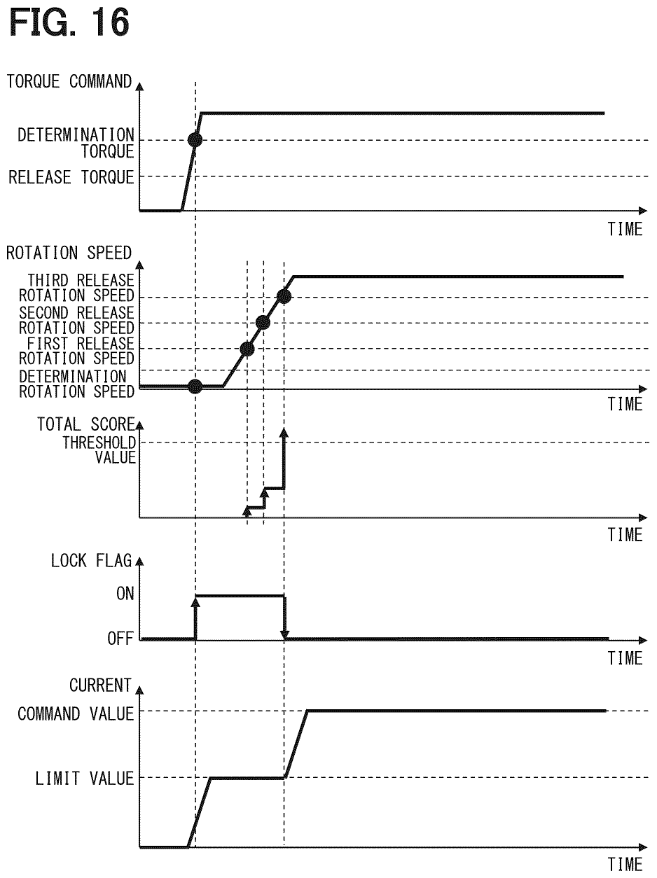

FIG. 16 is a time chart showing an example in which the second rotation speed and the third lock release rotation speed are set. For example, the rotation speed of the electric motor 30 is set as a parameter for setting the lock release condition, the first lock release rotation speed is set as the lock release condition, and at least one second lock release condition is set for determining that the locked state of the electric motor 30 has been released with a higher probability than the first lock release rotation speed.

In the example shown in the time chart of FIG. 16, the control device 40 compares the rotation speed of the electric motor 30 with each release rotation speed at each predetermined period. When the rotation speed of the electric motor 30 is equal to or higher than the first release rotation speed, the control device 40 calculates the score (for example, 1 point) for the case where the rotation speed is equal to or higher than the first release rotation speed as the total score. Even if the rotation speed of the electric motor 30 becomes equal to or higher than the first release rotation speed once, the total score does not exceed the threshold value. In the next determination cycle, when the rotation speed of the electric motor 30 is equal to or greater than the second release rotation speed, the control device 40 adds the score (e.g., 2 points) when the rotation speed is equal to or greater than the second release rotation speed to the already calculated total score to calculate the total score. Again, the total score still does not exceed the threshold value. Furthermore, in the next determination cycle, when the rotation speed of the electric motor 30 is equal to or greater than the third release rotation speed, the control device 40 adds the score (e.g., 10 points) when the rotation speed is equal to or greater than the third release rotation speed to the already calculated total score to calculate the total score. In the example shown in the time chart of FIG. 16, since the calculated total score exceeds the threshold value at this point, it is assumed that the predetermined period has elapsed, and it is determined that the locked state of the electric motor 30 has been resolved.

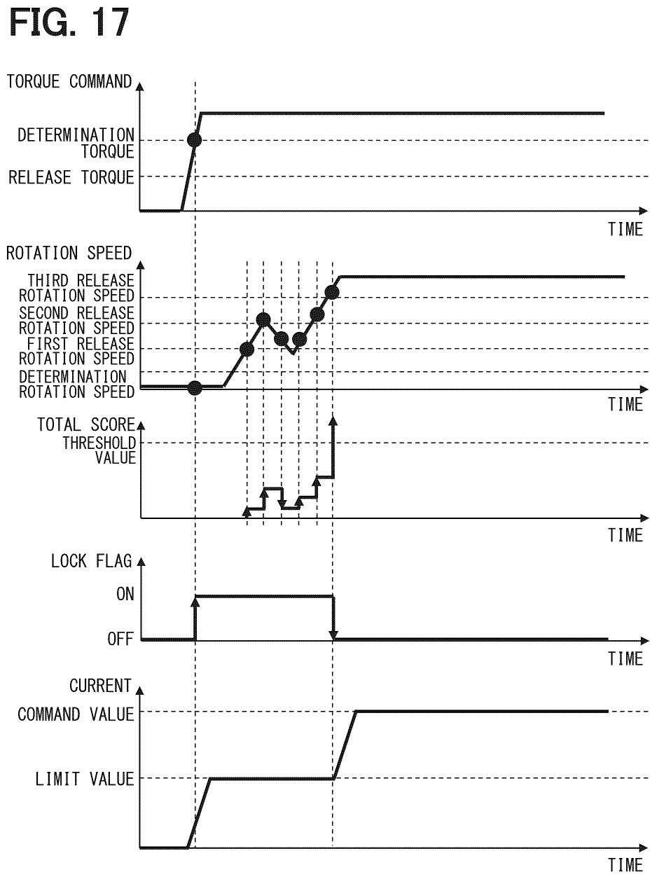

Also, as shown in the time chart of FIG. 17, when the rotation speed of the electric motor 30 once becomes equal to or higher than the second release rotation speed but then drops below the second release rotation speed, for example, the points for when the rotation speed becomes equal to or higher than the second release rotation speed may be subtracted from the total points. The subtraction value may be greater than or less than the score when the rotation speed of the electric motor 30 reaches or exceeds the second release rotation number. Furthermore, the previous value and the current value of the rotation speed of the electric motor 30 may be compared, and points may be added to the total only if the current value is greater than the previous value.

In the present embodiment, when the rotation speed of the electric motor 30 drops below the reset rotation speed, which is set to be equal to or lower than the first release rotation speed, the total value calculated up to that point is reset, and measurement for the specified period is stopped. In addition, the specified period corresponding to the lock release condition set for the rotation speed and/or torque command of the electric motor 30, or a parameter related to at least one of them, may be changed by changing the threshold value based on the temperature of the switching module 24 or a parameter related thereto, such as the coolant temperature or coolant flow rate of the cooling device 26.

The present disclosure is explained with a preferred embodiment as described above. However, the present disclosure is not limited to the above-mentioned embodiment, and may be variously modified within the spirit and scope of the present disclosure.

For example, in each of the above-described embodiments, the electric motor 30 is used to generate driving force for a vehicle, but the electric motor 30 may be used for other purposes.

What is claimed is:

1. An electric motor control device for controlling an electric motor to which current is passed through an inverter, comprising:
a processor with a memory storing computer program code executable by the processor, the processor configured to cause the electric motor control device to:
determine a locked state of the electric motor;
limit a current supplied to the electric motor when the locked state of the electric motor is determined;
determine whether a release condition for releasing the locked state of the electric motor is satisfied; and
terminate limiting the current to the electric motor when a period during which the release condition is satisfied continues for a specified period, by regarding the electric motor as having exited the locked state, wherein
the specified period is determined individually for each of the plurality of release conditions,
the processor is further configured to cause the electric motor control device to
determine whether each of a plurality of release conditions is satisfied, and
terminate limiting the current to the electric motor when any of the specified periods individually determined for each of the plurality of release conditions has elapsed, by regarding the electric motor as having exited the locked state.

2. The electric motor control device according to claim 1, wherein
the processor is further configured to cause the electric motor control device to
cancel measurement of the specified period when a cancellation condition for canceling an establishment of the release condition is satisfied before the specified period has elapsed.

3. The electric motor control device according to claim 1, wherein
the release condition is set for at least one of a rotation speed of the electric motor, a torque command that commands a torque to be generated by the electric motor, and an element temperature of the inverter, or at least one of parameters related to the rotation speed, the torque command, and the element temperature.

4. The electric motor control device according to claim 1, wherein
the release condition is set for a parameter related to at least one of a rotation speed of the electric motor and a torque command that commands a torque to be generated by the electric motor, and
the processor is further configured to cause the electric motor control device to,
detect a parameter related to an element temperature of the inverter, and set the specified period so as to shorten the specified period set in accordance with the release condition when an element temperature of the inverter is low compared to when the element temperature of the inverter is high, based on a detected parameter related to the element temperature of the inverter.

5. The electric motor control device according to claim 1, wherein
the plurality of release conditions are set for the same parameter, and
the specified periods individually determined for the plurality of release conditions set for the same parameter are different from each other.

6. The electric motor control device according to claim 5, wherein
the same parameter is a rotation speed of the electric motor, or a parameter correlated with the rotation speed of the electric motor,
the plurality of release conditions include at least a first release condition that the electric motor rotates at or above a first rotation speed, and a second release condition that the electric motor rotates at or above a second rotation speed that is higher than the first rotation speed, and
the specified period determined individually for the second release condition is shorter than the specified period determined individually for the first release condition.

7. The electric motor control device according to claim 5, wherein
the same parameter is a torque command that commands a torque to be generated by the electric motor or a parameter that is correlated with the torque command,
the plurality of release conditions include at least a first release condition that the torque command is equal to or less than a first torque, and a second release condition that the torque command is equal to or less than a second torque that is lower than the first torque, and
the specified period determined individually for the second release condition is shorter than the specified period determined individually for the first release condition.

8. The electric motor control device according to claim 1, wherein
the processor is further configured to cause the electric motor control device to
measure the specified period by using a timer that starts counting time when the release condition is satisfied, or by determining at regular intervals whether the release condition is satisfied and determining that the release condition is satisfied a predetermined number of times in succession, thereby measuring the specified period.

9. The motor control device according to claim 8, wherein
the predetermined number of times varies depending on the specified period that is individually determined for each of the plurality of release conditions.

10. The motor control device according to claim 8, wherein
the regular interval varies depending on the specified period that is individually determined for each of a plurality of the release conditions.

11. The electric motor control device according to claim 1, wherein
at least one second release condition is defined for determining that the locked state is released with a higher probability than that of the parameter for which the release condition is set, and
the processor is further configured to cause the electric motor control device to
determine at a predetermined interval whether the release condition and the second release condition are satisfied,
calculate a total score of the score when the release condition is satisfied and a score when the second release condition, which is set higher than the score when the release condition is satisfied, while the release condition is continuously satisfied, and
when the total score exceeds a threshold value, consider that the specified period has elapsed.

12. The electric motor control device according to claim 1, wherein
the processor is further configured to cause the electric motor control device to
reserve limiting the current supplied to the electric motor for a predetermined reservation time from a start of operation of the electric motor even if the electric motor is in a locked state.

13. The electric motor control device according to claim 1, wherein
the electric motor is used to drive a vehicle.

14. A storage medium storing an electric motor control program for controlling an electric motor energized through an inverter, comprising:
the program including instructions configured, when executed by at least one processor, to cause the at least one processor to function as
determining a locked state of the electric motor;
limiting a current supplied to the electric motor when it is determined that the electric motor is locked;
determining whether a release condition for determining whether the locked state of the electric motor is released is satisfied; and
terminating a limit of the current supplied to the electric motor by determining that the locked state of the electric motor is released when a period during which the release condition is satisfied continues for a specified period, wherein
an instruction to determine whether the release condition is satisfied determines whether each of the release conditions is satisfied for a plurality of the release conditions,
the specified period is determined individually for each of the plurality of release conditions, and
an instruction to terminate the limit of the current flowing through the electric motor is issued when any of the specified periods individually determined for each of the plurality of release conditions is elapsed, and terminate the limit of the current flowing through the electric motor, assuming that the locked state of the electric motor is released.

15. An electric motor control device for controlling an electric motor to which current is passed through an inverter, comprising:
a locked state determination unit configured to determine a locked state of the electric motor;
a current limit unit configured to limit a current supplied to the electric motor when the locked state determination unit determines that the electric motor is in a locked state;
a release determination unit configured to determine whether a release condition for determining whether the locked state of the electric motor is released is satisfied; and
a limitation terminating unit configured to, when a period during which the release condition is satisfied continues for a specified period, determine that the locked state of the electric motor is released and ends the current limitation by the current limit unit, wherein
the release determination unit determines whether each of a plurality of release conditions is satisfied,
the specified period is determined individually for each of the plurality of release conditions, and
the limitation terminating unit determines that the locked state of the electric motor is released when any of the specified periods individually determined for each of the plurality of release conditions has elapsed, and terminates the current limitation by the current limit unit.
